(19) United States
(12) Patent Application Publication
(10) Pub. No.: US 2009/0129272 A1
(43) Pub. Date: May 21, 2009

(54) METHOD AND APPARATUS TO CONTROL DATA RATE IN A WIRELESS COMMUNICATION SYSTEM

(75) Inventors: DAVID C. PADFIELD, MARLBOROUGH (GB); LORENZ F. FREIBERG, SWINDON (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/942,792

(22) Filed: Nov. 20, 2007

(51) Int. Cl. H04L 1/00

(52) U.S. Cl. 370/235

(57) ABSTRACT

A serving radio network controller controls the data rate for uplink and downlink transmissions between a mobile device and a serving access point by negotiating with a drift radio network controller of a drift access point in a wireless communication system. The serving radio network controller receives a first message from the drift radio network controller, wherein the first message includes information indicating a first maximum data rate for transmissions between the mobile device and the drift access point. Based on the information indicating the first maximum data rate, the serving access point determines a second maximum data rate for transmissions between the mobile device and the serving access point.

### FIELD OF THE DISCLOSURE

The present disclosure relates generally to wireless communications and more particularly to a method and apparatus to control data rate in a wireless communication system.

### BACKGROUND

In some wireless communication systems a mobile device establishes a link with at least one access point to communicate with another mobile/fixed-line communication device. Typically, the established link is a duplex link. Transmission of data and control information from the mobile device to the access point is known as uplink transmission and transmission of data and control information from the access point to the mobile device is known as downlink transmission. The access point can determine a data rate for uplink and downlink transmissions based on a plurality of measurement reports. The access point collects the plurality of measurement reports from a local cell that roughly defines a radio coverage region of the access point. The measurement reports may include a plurality of items such as interference measurements, signal strength measurements, power measurements of transmitted signals, and the like.

Some wireless communication system topologies comprise a plurality of access points each having its own radio coverage region i.e. cell. Within such systems a mobile device often moves from the radio coverage region of one access point into the radio coverage region of another access point. In this situation, a mobile device performs a handoff operation to maintain an ongoing call. Alternatively, the mobile device can perform a handoff operation to establish a radio link with a new access point. When the mobile node maintains a connection with multiple access points during the handoff, the handoff operation is generally referred to as a soft handoff operation. Accordingly, the access point which serves to control communications of the mobile device is called a serving access point. The new access point is called the drift access point. The mobile device performs a handoff operation between the serving access point and the drift access point whilst the mobile device is moving from the radio coverage region of the serving access point into the radio coverage region of the drift access point.

Often the radio coverage regions associated with the serving access point and the drift access point could be classified as micro cells, pico cells, and femto cells based on the size of the radio coverage regions. Sometimes, the mobile device may take relatively long time to complete the soft handoff operation when the radio coverage regions associated with the serving access point and/or the drift access point are micro, pico, or femto cells. During the long state of the handoff operation, there may be a need to change the data rate for uplink and downlink transmissions between the mobile device and the drift and/or the serving access points.

Conventionally, the serving access point determines the data rate for uplink and downlink transmissions based on measurement reports collected from within the local cell, i.e., the radio coverage region of the serving access point. However, the drift access point may not support the determined data rate for uplink and downlink transmissions once the mobile device completes the handoff operation. In the above situation, the mobile device would be subjected to suddenly switch to a data rate supported by the drift access point. The sudden switching of the data rate initiates a synchronization reconfiguration procedure to synchronize the transmissions between the mobile device and the drift access point. The synchronization reconfiguration procedure takes significant time for execution. Moreover, the synchronization reconfiguration process increases processing load and processing delay at the drift access point.

Thus, there exists a need for a different technique to control the data rate for uplink and downlink transmissions at the serving access point which addresses at least some of the shortcomings of past and present methods to control the data rate for uplink and downlink transmissions in a wireless communication system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communications system in accordance with some embodiments.

FIG. 2 is a flowchart of a method to control the data rate in the wireless communication system in accordance with some embodiments.

FIG. 3 is a schematic of a serving access point which controls the data rate in the wireless communication system in accordance with some embodiments.

FIG. 4 is a signaling diagram illustrating a serving access point controlling the data rate in the wireless communication system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to various embodiments a serving access point controls data rate for uplink and downlink transmissions in a wireless communication system. The wireless communication system comprises a mobile device, the serving access point that includes a serving radio network controller, and a drift access point that includes a drift radio network controller. The serving radio network controller receives a first message from the drift radio network controller, wherein the first message includes information indicating a first maximum data rate for transmissions between the mobile device and the drift access point. Based on the information indicating the first maximum data rate, the serving access point determines a second maximum data rate for transmissions between the mobile device and the serving access point.

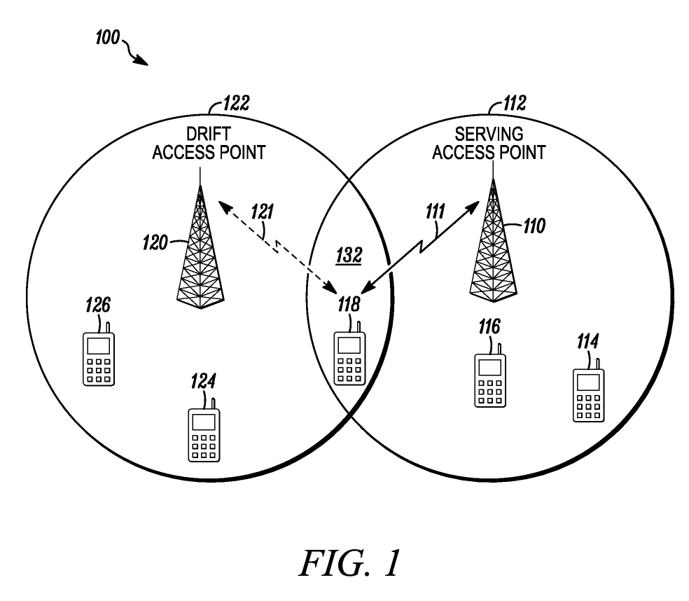

Referring now to the drawings, and in particularly FIG. 1, a block diagram illustrating a wireless communication system is shown and indicated at 100. The wireless communication system 100 uses a method to control data rate for uplink and downlink transmissions between a mobile device and an access point in accordance with some embodiments of the invention. Those skilled in the art, however, will recognize and appreciate that the specifics of this example are merely illustrative of some embodiments and that the teachings set forth herein are applicable in a variety of alternative settings. For example, in some embodiments, the access points and the mobile devices operate in accordance with standards promulgated by 3^{rd} generation Partnership Project (3GPP), such as the standard for Universal Mobile telecommunications system Terrestrial Radio Access Network (UTRAN). However, the teachings herein are in no way limited to this system implementation. Moreover, the system may include more or fewer access points than is shown in FIG. 1.

The wireless communication system 100 comprises a serving access point 110 and a drift access point 120. As used herein, the term access point includes, but is not limited to, equipment commonly referred to as base transceiver stations, site controllers, or any other type of interfacing device in a wireless environment. The access points comprise at least transceiver apparatus (i.e., a transmitter and receiver), a processing device, and an interface for communication with another access point or a mobile device, wherein the interface may be a fixed-line interface or a wireless interface established using any suitable protocol, such as a Radio Network Subsystem Application Part (RNSAP) signaling protocol. The access points may further comprise any suitable memory device for carrying out its functionality. Moreover, embodiments of access points described herein comprise a radio network subsystem (RNS). The RNS at least logically comprises a radio responsible for transmission and reception, modulation and demodulation, error handling, etc., within the radio coverage region of the access point; and a radio network controller (RNC) responsible for the use of radio resources for establishing links within the radio coverage region of the access point, wherein such use of radio resources including, but not limited to, radio resource control, admission control, channel allocation, power control settings, handover control, etc.

The serving access point 110 has an associated radio coverage region 112. Also, the drift access point 120 has an associated radio coverage region 122. The radio coverage region 112 associated with the serving access point 110 is roughly the area in which signal strength of radio signals from the serving access point 110 is above certain threshold. Similarly, the radio coverage region 122 associated with the drift access point 120 is roughly the area in which signal strength of radio signals from the drift access point 120 is above certain threshold. Often, the radio coverage regions associated with the serving access point 110 and the drift access point 120 overlap. A common radio coverage region 132 is roughly the overlapping area of the radio coverage regions 112 and 122.

The wireless communication system 100 further comprises a plurality of mobile devices 114, 116, 118, 124, and 126. As used herein, the term mobile device includes, but is not limited to, equipment commonly referred to as access devices, access terminals, user equipment, mobile stations, mobile subscriber units, and any other device capable of operating in a wireless environment. The mobile devices comprise at least transceiver apparatus (i.e., a transmitter and receiver), a processing device, and an interface for communication with an access point or another mobile device, wherein the interface may be a fixed-line interface or a wireless interface established using any suitable protocol. The mobile devices may further comprise any suitable memory device for carrying out its functionality.

The plurality of mobile devices 114, 116, 118, 124, and 126, at any time, could be located at different positions in the wireless communication system 100. For example, mobile devices 114 and 116 are located in the radio coverage region 112 associated with the serving access point 110 and the mobile devices 124 and 126 are located in the radio coverage region 122 associated with the drift access point 120. Those skilled in the art will recognize and appreciate that each mobile device may be, but is not limited to, one of the following communication devices: cellular telephones, wireless personal data assistants, mobile computers, and the like.

The plurality of mobile devices 114, 116, 118, 124, and 126 communicate with each other or with other mobile/fixed-line communication devices (not shown) via the serving access point 110 and/or the drift access point 120. Each mobile device establishes a communication link with at least one of the serving access point 110 or the drift access point 120 to communicate data via them. For example, the mobile device 118 communicates with other mobile/fixed-line communication devices (not shown) via the serving access point 110 by establishing a communication link 111, which comprises the physical communication resources over which information is sent between the mobile device 118 and the access point 110.

Often, one or more mobile devices amongst the plurality of mobile devices in the wireless communication system 100 are in motion. For example, the mobile device 118 could be moving out of the radio coverage region 112 associated with the serving access point 110 into the radio coverage region 122 associated with the drift access point 120. As shown in FIG. 1, the mobile device 118 is located in the common radio coverage region 132. In the above described situation, the mobile device 118 performs a handoff operation to maintain/support active communications. For example, in the above described situation, the mobile device 118 would perform a handoff operation between the serving access point 110 and the drift access point 120. Typically, the handoff operation is a soft handoff operation. The mobile device 118 establishes a link 121 with the drift access point 120 whilst communicating with other mobile/fixed-line communication devices (not shown) via the serving access point 110. During the handoff operation the serving access point 110 determines the data rate for uplink and downlink transmissions in accordance with the embodiments of the invention.

As described herein, the mobile node is in a state of handoff with a single drift access point. However, those of ordinary skill in the art will realize that in certain situations (e.g., where the mobile node is within the coverage area of multiple drift access points (not shown)) the mobile node can establish links, and thereby be in a state of soft handoff, with multiple drift access points. For example, the mobile device 118 can perform a 3-way soft handoff operation with the serving access point and two drift access points. Thus, it should be realized that the teachings herein are also applicable in such situations where the mobile device is in a state of handoff with multiple drift access points.

In such a case, the serving access point RNC is additionally coupled to the RNCs of the other drift access points. The serving access point RNC receives information from the multiple drift access point RNCs indicating a maximum data rate for transmission, respectively, between the mobile device and each of the additional drift access points. The serving access point uses this additional information to determine a data rate for transmissions between the mobile device and the serving access point in accordance with the teachings herein.

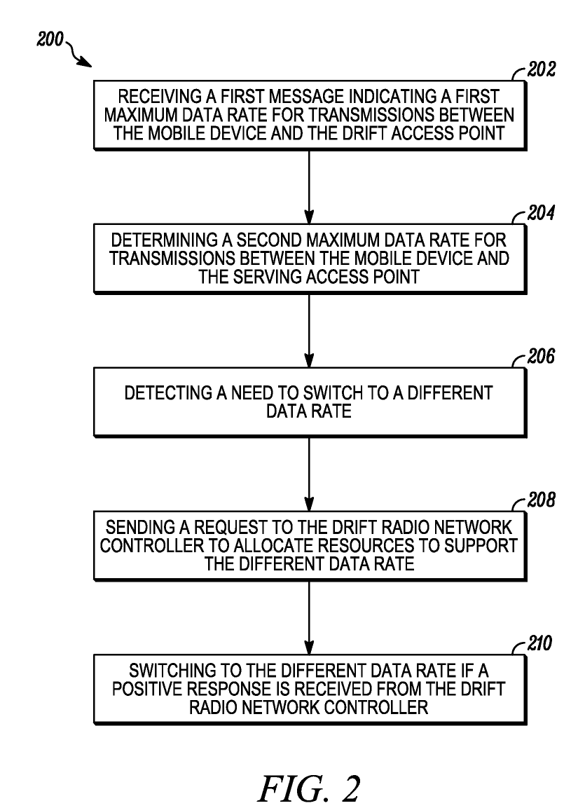

Turning now to FIG. 2, a flow diagram illustrating a method to control the data rate in a wireless communication system in accordance with some embodiments is shown and indicated at 200. The wireless communication system comprises at least a mobile device, a serving access point that includes a serving radio controller and a drift access point that includes a drift radio network controller to implement the method 200. It should be realized that the method 200 illustrated by reference to FIG. 2 includes functionality that may be performed in hardware, firmware, software or a combination thereof and may further be performed at a single hardware device or a combination of hardware devices at the serving access point. Also, one or more steps of the method illustrated at 200 can be performed at supporting hardware units external to the serving access point.

In general the method 200 comprises: receiving (202) a first message from the drift radio network controller that includes information indicating a first maximum data rate for transmissions between the mobile device and the drift access point; determining (204) a second maximum data rate for transmissions between the mobile device and the serving access point based on the information indicating the first maximum data rate; detecting (206) a need to switch to a different data rate for transmissions between the mobile device and the serving access point; sending (208) to the drift radio network controller a request to allocate resources to support the different data rate for transmissions between the mobile device and the drift access point; and switching (210) to the different data rate for transmissions between the mobile device and the serving access point if a positive response to the request to allocate resources is received from the drift radio controller.

Illustrative details for implementing the method 200 will next be described. At 202, the serving radio controller receives a first message from the drift radio network controller. The first message includes information indicating a first maximum data rate for transmissions between the mobile device and the drift access point. In one embodiment, the first message is a response to a request from the serving radio network controller. Generally, the drift radio network controller determines the first maximum data rate by using measurement reports. The measurement reports may include a plurality of data items such as interference measurements, signal strength measurements, power measurements of transmitted signals, and the like. Basically, the measurement reports indicate resource availability at the drift access point. Based, on the resource availability the drift radio network controller determines the maximum data rate for transmissions that can be supported by the drift access point.

In an embodiment, the measurement reports from the drift access point are generated based on internal measurements by the radio (also referred to as the base station or Node B) of the drift access point of current/average RF signal level in the receiver and current/average available headroom for downlink RF power in the transmitter. In another embodiment, the measurement reports from the drift access points are generated based on measurements made by the mobile device and reported back to the RNC of the drift access point, e.g., measurement reports that are generated using a Measurement Control procedure. The teachings herein cover both embodiments.

Once, the serving radio network controller acquires the knowledge about the maximum data rate supported by the drift access point for transmission between the mobile device and the drift access point, at 204, the serving radio controller determines a second maximum data rate for transmissions between the mobile device and the serving access point. The serving radio controller determines the second maximum data rate based on measurement reports that indicate resource availability at the serving access point and the received information indicating the first maximum data rate supported by the drift access point. The serving radio network controller switches to the second maximum data rate (not shown). Likewise, measurement reports generated at the serving access point and related to resource availability within the coverage area of the serving access point may be generated based on internal measurement by the Node B of the serving access point and/or measurements made at the mobile device and reported to the RNC of the serving access point.

Once a nominal data rate is set by the serving radio network controller (at 204), often, there may be a need to switch to a different data rate. Generally, the different data rate is a data rate higher than the second maximum data rate. Steps 206, 208, and 210 describe embodiments related to that particular scenario. At 206, the serving radio network controller detects a need to switch to a different data rate. In one embodiment, detecting the need to switch to a different data rate comprises receiving a request from the mobile device to switch to the different data rate. This may occur, for instance, where the mobile device determines based on link quality indicators, e.g., carrier to interference (C/I) or signal to noise ratio (SNR) estimations, that the nominal data rate is too conservative for current link conditions, and/or the mobile may have a demand to send more data.

In an alternate embodiment, the serving radio network controller detects a need to switch to a different data rate based on the measurement reports from the radio coverage region of the serving and/or the drift access point. For example, the serving radio network controller can receive a measurement report that indicates data volume in the radio coverage region (cell) of the drift access point in which the mobile device is located. The serving radio network controller detects a need to switch to a different data rate by determining if the data volume exceeds a predetermined threshold.

At 208, the serving radio network controller checks if the drift radio network controller can support the different data rate. The serving radio network controller sends a request to the drift radio network controller to allocate resources to support the different data rate. The drift radio network controller determines if it can support the different data rate based on the measurement reports collected from the local cell i.e. the radio coverage region of the drift access point. Based on the available resources the drift radio network controller sends a response to the serving radio network controller. At 210, the serving radio network controller switches to the different data rate if a positive response is received from the drift radio network controller. In case of a negative response, the serving radio network controller can negotiate a data rate lower than the different data rate with the drift radio network controller. In one embodiment, the negotiation process involves repetition of steps 208 and 210. The serving access point finally sets a data rate which is supported by both of the serving radio network controller and the drift radio network controller.

Those skilled in the art will recognize and appreciate that the specifics of the method 200 are merely illustrative of some embodiments and that the teachings set forth herein are applicable to a variety of alternate settings. For example, method 200 is applicable to control the data rate for both uplink and downlink transmissions between a mobile device and an access point. An access point can determine if it can support a particular data rate for uplink transmissions based on uplink interference measurements. Generally, the uplink interference measurements are obtained from the signal strength measurements within the cell. Moreover, the access point uses downlink interference measurement to determine if it can support a particular data rate for downlink transmissions. Generally, measurement of downlink interference is based on downlink power measurements. Both the uplink interference measurements and downlink power measurements are a part of measurement reports described above.

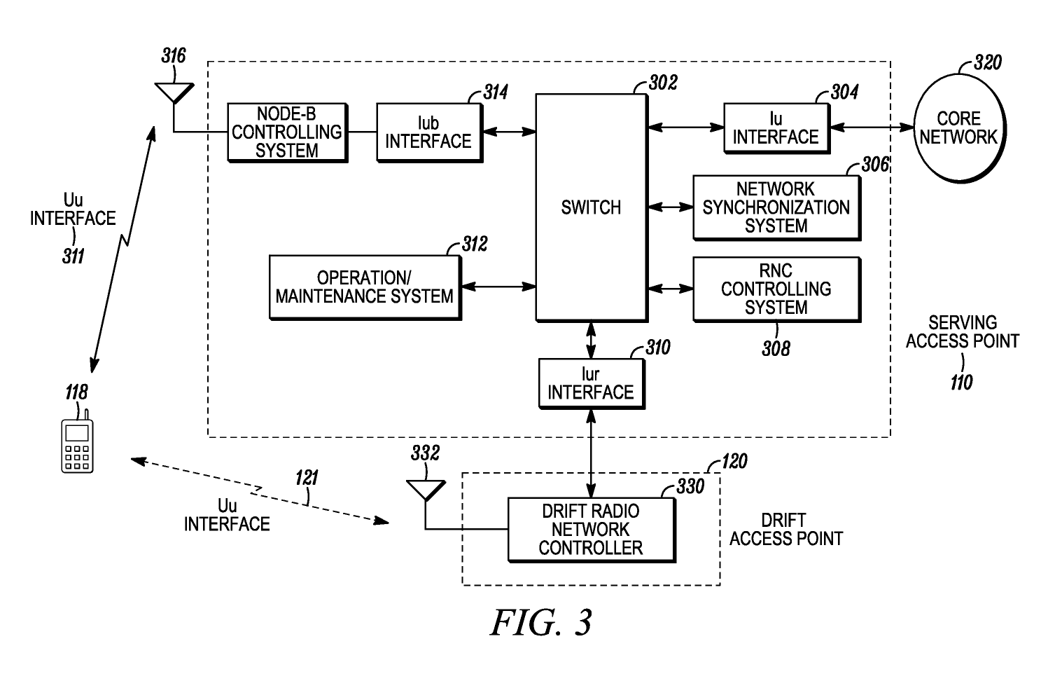

FIG. 3 illustrates a schematic of the serving access point (e.g., the serving access point 110) that controls the data rate in the wireless communication system 100 in accordance with some embodiments. FIG. 3 shows the serving access point 110 comprising: a switch 302, a network synchronization system 306, a RNC controlling system 308, an operation/maintenance system 312, a Node-B 316 and an antenna 318. The switch 302 provides communication paths for the flow of traffic signals and control signals between a plurality of hardware entities internal and/or external to the serving access point 110. The network synchronization system 306 maintains a synchronization state between the serving access point 110, the drift access point 120, and the mobile device 118. Often, the network synchronization system 306 performs a synchronization reconfiguration process to synchronize communication between the mobile device 118 and the serving access point 110. Operation/Maintenance system 312 is used to control the operations and for the maintenance of the serving access point 110. The Node-B 316 enables the serving access point 110 to receive/transmit data and control signals from/to the mobile device 118 through an antenna 318 and performs functions such as modulation and demodulation of RF signals. In an embodiment, the Node-B 316 performs all functions of a Node-B defined in a Universal Mobile Telecommunications System (UMTS) network.

The RNC controlling system 308 performs the functions of processing calls, collecting measurement reports, processing the measurement reports, and generating control signals to communicate with a plurality of external and internal hardware units. The RNC controlling system 308 typically has a processor embedded within which performs the above mentioned functions. Generally the RNC controlling system 308, the switch 302, and few other hardware entities (not shown) constitute a serving radio network controller.

FIG. 3 also illustrates a core network 320 and the drift access point 120 comprising a drift radio network controller 330, and an antenna 332. The serving access point 110 further comprises an Iu interface 304, Iur interface 310, and Iub interface 314. The serving access point 110 communicates with the core network 320 using the Iu interface 304. Also, the serving access point 110 communicates with the mobile device 118 using the Iub interface 314 and the Node-B 316 through the antenna 318. Generally, the radio interface between the mobile device 118 and the antenna 318 of the serving access point is a Uu interface 311. The serving radio network controller communicates with the drift radio network controller 330 using the Iur interface 310.

The mobile device 118 communicates with the serving access point 110 using the Uu interface 311. If the mobile device 118 is moving from a coverage region of the serving access point 110 into the coverage region of the drift access point 120, the mobile device 118 typically performs a soft handoff operation between the serving access point 110 and the drift access point 120. In the above mentioned scenario, the mobile device 118 establishes a link 121 (soft leg) to communicate with the drift access point 120. Generally, the radio interface for the link 121 is a Uu interface. The serving radio network controller determines a data rate for uplink and downlink transmissions between the mobile device 118 and the serving access point 110 by negotiating the data rate with the drift radio network controller 330 over the Iur interface 310. Generally, the serving radio network controller communicates with the drift radio network controller 330 using Radio Network Subsystem Application Part (RNSAP) signaling protocol.

Those skilled in the art will recognize and appreciate that the specifics of the schematic of the serving access point 110 shown in FIG. 3 are merely illustrative of some embodiments and that the teachings set forth herein are applicable to a variety of alternate settings. For example, the Iu interface 304, the Iub interface 314, the Iur interface 310, and the Uu interface 311 are specific interfaces related to Universal mobile telecommunications system Terrestrial Radio Access Network (UTRAN). However, since the teachings described do not depend on any particular communication system, they can be applied to any type of communication system. As such, other alternate implementations using any type of application layer interfaces are contemplated and within the scope of the various teachings described. For example, in an alternative embodiment, network 100 further comprises a General Packet Radio Services (GPRS) network topology as described in open standards as promulgated by 3GPP. In this implementation, both the Iu interface (304) and a Serving GPRS Support Node (SGSN) are to the access point, so that the external interface to the core network 320 is a Gi interface (IP) defined in the GPRS standard.

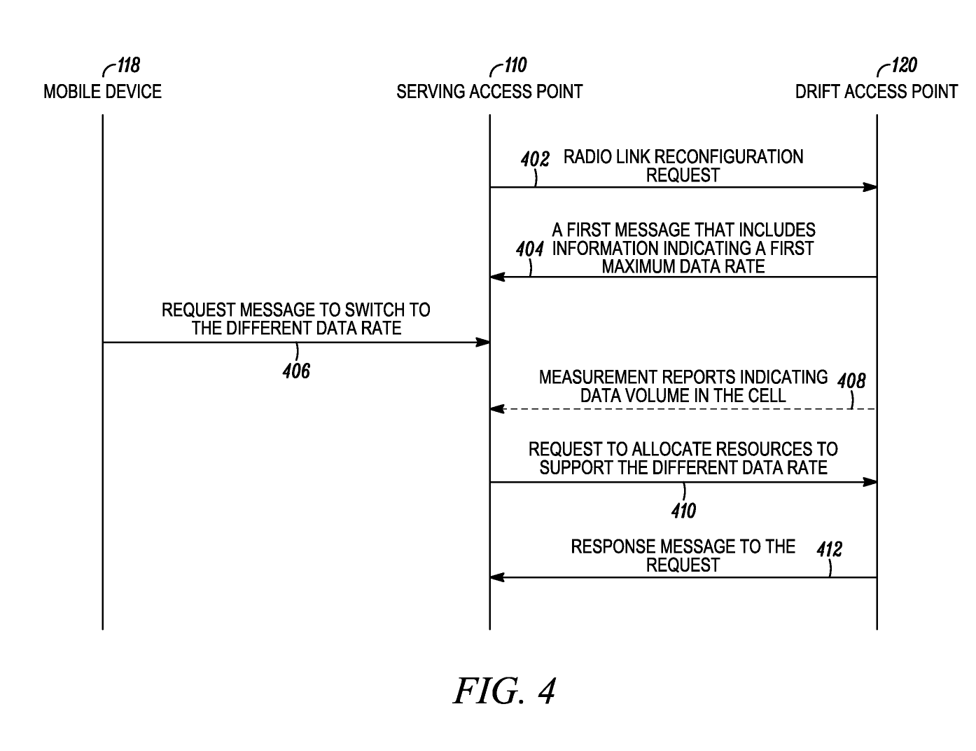

FIG. 4 is a signaling diagram illustrating a serving access point (e.g., the serving access point 110) controlling the data rate in the wireless communication system in accordance with some embodiments. The serving access point 110 sends a radio link reconfiguration request 402 to the drift access point 120 after it detects a handoff situation wherein the mobile device 118 needs to perform a handoff from the serving access point 110 to the drift access point 120 to maintain active communications. In an embodiment, the reconfiguration request is part of a Transport Format Combination Control (TFCC) procedure to change the data rate. The drift access point 120 sends a first message 404 that includes information indicating a first maximum data rate supported by the drift access point 120. In one illustrative embodiment, the information indicating a first maximum data rate is included in contents of an information element identified in the RNSAP signaling protocol. The first maximum data rate is a data rate for transmissions between the mobile device 118 and the drift access point 120 on the new radio link. The serving access point 110 determines a data rate for transmissions between the mobile device 118 and the serving access point based on the received first maximum data rate.

In one embodiment, a user associated with the mobile device 118 may desire a higher data rate. In this scenario, the mobile device 118 sends a request message 406 to the serving access point 110 to switch to a different data rate. In an alternate embodiment, the serving access point 110 detects a need to switch to a different data rate based on the measurement reports 408 indicating data volume received from the drift access point 120. After detecting a need to switch to the different data rate, the serving access point 110 sends a request (410) to the drift access point 120 to allocate resources to support the different data rate. Based on the available resources, the drift access point 120 determines if it can support the different data rate. The drift access point 120 sends a response message 412 to the request. The response message 412 indicates if the drift access point 120 can support the different data rate. If the response message 412 is a positive response message the serving access point switches to the different data rate otherwise the serving access point 110 negotiates a data rate less than the different data rate with the drift access point 120 or maintains the current data rate if a different data rate cannot be negotiated.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for controlling data rate in a wireless communication system, the system comprising a mobile device, a serving access point that includes a serving radio network controller, and a drift access point that includes a drift radio network controller, the method comprising:
at the serving radio network controller:
receiving a first message from the drift radio network controller that includes information indicating a first maximum data rate for transmissions between the mobile device and the drift access point;
determining a second maximum data rate for transmissions between the mobile device and the serving access point based on the information indicating the first maximum data rate.

2. The method of claim 1, wherein the first maximum data rate a first maximum uplink data rate or a first maximum downlink data rate.

3. The method of claim 1, wherein the second maximum data rate of a second maximum uplink data rate or a second maximum downlink data rate.

4. The method of claim 2, wherein the first maximum uplink data rate is determined based on a measurement of uplink interference at the drift access point.

5. The method of claim 4, wherein the measurement of uplink interference is made based on signal strength measurements within a cell of the drift access point in which the mobile device is located.

6. The method of claim 2, wherein the first maximum downlink data rate is determined based on a measurement of downlink interference at the drift access point.

7. The method of claim 6, wherein the measurement of downlink interference is based on downlink power measurements.

8. The method of claim 1, wherein the serving radio network controller and the drift radio network controller communicate over an application layer interface.

9. The method of claim 1, wherein the serving radio network controller and the drift radio network controller communicate over an Iur interface.

10. The method of claim 1, wherein the serving radio network controller and the drift radio network controller communicate using Radio Network Subsystem Application Part (RNSAP) signaling protocol.

11. The method of claim 10, wherein the information indicating a first maximum data rate is included in contents of an information element identified in the RNSAP signaling protocol.

12. The method of claim 1 further comprising:
at the serving radio network controller:
detecting a need to switch to a different data rate for transmissions between the mobile device and the serving access point;
sending to the drift radio network controller a request to allocate resources to support the different data rate for transmissions between the mobile device and the drift access point;
switching to the different data rate for transmissions between the mobile device and the serving access point if a positive response to the request to allocate resources is received from the drift radio network controller.

13. The method of claim 12, wherein detecting the need to switch to the different data rate comprises receiving a request from the mobile device to switch to the different data rate.

14. The method of claim 12, wherein detecting a need to switch to the different data rate comprises:
receiving a measurement report that indicates data volume in a cell of the drift access point in which the mobile device is located;
determining that the data volume exceeds a predetermined threshold, which indicates the need to switch to the different data rate.

15. The method of claim 12, wherein the different data rate is a higher data rate than the second maximum data rate.

16. A device operable to control data rate in a wireless communication system, the system comprising a mobile device and a drift access point that includes a drift radio network controller, the device comprising:
an interface for receiving a first message from the drift radio network controller that includes information indicating a first maximum data rate for transmissions between the mobile device and the drift access point; and
a serving radio network controller determining a second maximum data rate for transmissions between the mobile device and the serving access point based on the information indicating the first maximum data rate.

17. The device of claim 16, wherein the serving radio network controller comprises:
a switch; and
a Radio Network Controller (RNC) controlling system.

18. The device of claim 16, wherein the interface comprises an Iur interface defined in the 3^{rd} Generation Partnership Project (3GPP) standard for Universal mobile telecommunications system Terrestrial Radio Access Network (UTRAN).
